(19) United States
(12) Patent Application Publication
(10) Pub. No.: US 2007/0103568 A1
(43) Pub. Date: May 10, 2007

(54) Method of enlarging an image by interpolation means and a related digital camera using the same

(75) Inventor: Hung-Wei Chen, Taipei (TW)

Correspondence Address: BACON & THOMAS, PLLC, 625 SLATERS LANE, FOURTH FLOOR, ALEXANDRIA, VA, 22314, US

(73) Assignee: PREMIER IMAGE TECHNOLOGY CORPORATION, Taipei (TW)

(21) Appl. No.: 11/415,255

(22) Filed: May 2, 2006

(30) Foreign Application Priority Data
Nov. 10, 2005 (TW) 094139480

(51) Int. Cl. H04N 5/262

(52) U.S. Cl. 348/239

(57) ABSTRACT

A method of enlarging an image by interpolation means and a related digital camera are disclosed. The method comprises: dividing an original image into a plurality of divided sections; defining a first divided section selected from the plurality of divided sections; defining a second divided section from the divided sections adjacent thereto and continuing until defining a final divided section; enlarging the first divided section by a first specific multiplier and zooming out by a second specific multiplier by using the interpolation means to form a first processed section, and continuing until a final processed section is formed. The first processed section to the final processed section thereby form an enlarged image.

### BACKGROUND OF THE INVENTION

1. Field of the Invention

The present invention relates to a method of enlarging an image and a related digital camera, and, more particularly, to a method of enlarging an image by an interpolation means and a related digital camera.

2. Description of the Related Art

One of the most important elements in digital cameras is a charge coupled device (CCD). The digital camera utilizes the CCD to convert impinging light signals into electronic signals, and records these signals in a built-in memory (such as a 32M or a 16M SDRAM) within the digital camera to form images.

The most basic unit of an image is the pixel; pixels are the points that compose the image. Therefore, images with more pixels are of better quality. For a 1,600×1,200 pixel image file, there are 1,920,000 pixels, meaning that the image is composed of 1,920,000 points. The maximum pixel resolution of the digital camera is determined by the number of the CCDs in the digital camera.

However, the CCD is an expensive element, and so the number of the CCD is usually limited in the digital camera. Therefore, some manufacturers utilize “interpolation means” to increase the number of pixels. The original image data with fewer pixels is operated upon the interpolation means to form an image data having more pixels.

Traditionally, the interpolation means is limited by the size of the buffer, because the buffer can only hold images of limited size. The general solution is to store the reduced image in the buffer and then store the enlarged image back into the memory in the digital camera. However, the enlarged image may cause saw-toothed edges, which degrade the image quality.

### SUMMARY OF THE INVENTION

A digital camera of the present invention enlarges an original captured image and stores the original captured image in a memory of the digital camera. The method of enlarging an original image of the present invention thus can provide the enlarged images with the same quality and require less buffer capacity to improve the functioning of the digital camera.

The digital camera of the present invention comprises a digital signal processor (DSP) and a memory. The memory stores an application program interface (API), and comprises a buffer and an image data storage area. An original image is capable of being stored in the image data storage area, and the application program interface is usable for calling the digital signal processor to zoom in on the original image.

The digital signal processor is used to perform the invention method of enlarging the original image, which comprises:

(a) dividing an original image into a plurality of divided sections;

(b) defining a first divided section selected from one of corner divided sections of the plurality of divided sections;

(c) defining sequential divided sections from the divided sections adjacent to the first divided section thereto and continuing until defining a final divided section;

(d) enlarging the first divided section by a first specific multiplier and reducing by a second specific multiplier by using the interpolation means; wherein the first specific multiplier is larger than the second specific multiplier so the first divided section is zoomed in as a first processed section by using the interpolation means; and

(e) enlarging the second divided section by the first specific multiplier and reducing by the second specific multiplier by using the interpolation means to form a second processed section, and repeating the process until a final processed section is formed, the first processed section to the final processed section thereby forming an enlarged image.

Generally, the enlargement or reduction multipliers of the digital signal processor are constants, which indicates that the enlargement multiplier for the original image is a fixed multiplier (such as 1.26 times or 1.28 times). Therefore, in the preferred embodiment of the present invention, the first specific multiplier is 2, and the second specific multiplier is 1.25×1.25. For example, the original image may be about a 3M pixel image, and the enlarged image might be about a 5M pixel image.

In the preferred embodiment of the present invention, each divided section has at least one overlapping area. After enlargement and reduction of the overlapped areas, visible dividing lines are not generated between the processed sections.

Furthermore, in the method, step (c) further comprises:

separately overlapping at least one area of the second divided section and the third divided section with the first divided section; and

separately overlapping at least one area of the divided sections adjacent the second divided section with the second divided section, and repeating the process with every divided section until the final divided section is reached.

The digital signal processor can be used for controlling the partition sizes of the divided sections and for obtaining very minor differences. Therefore, this embodiment can make overlapping areas having widths of only 2 to 4 pixels. By enlarging and reducing the divided sections to enhance the overlapping areas, visible division lines between every two processed sections are avoided, and so the entire enlarged image appears clearer.

### BRIEF DESCRIPTION OF THE DRAWINGS

FIG. 1 is a functional block drawing of a digital camera according to the present invention.

FIG. 2 is a flow chart of a method of the present invention.

FIG. 3A˜FIG. 3F are schematic drawings of enlarging on an original image according to the present invention.

FIG. 4 shows another embodiment of the present invention, which shows more divided sections.

FIG. 5 is a flow chart of a method of enlarging an original image according to the present invention.

FIG. 6A˜FIG. 6C show a method of enlarging an original image according to another embodiment of the present invention, which shows that divided sections all have at least one overlapping area.

### DETAILED DESCRIPTION OF THE PREFERRED EMBODIMENT

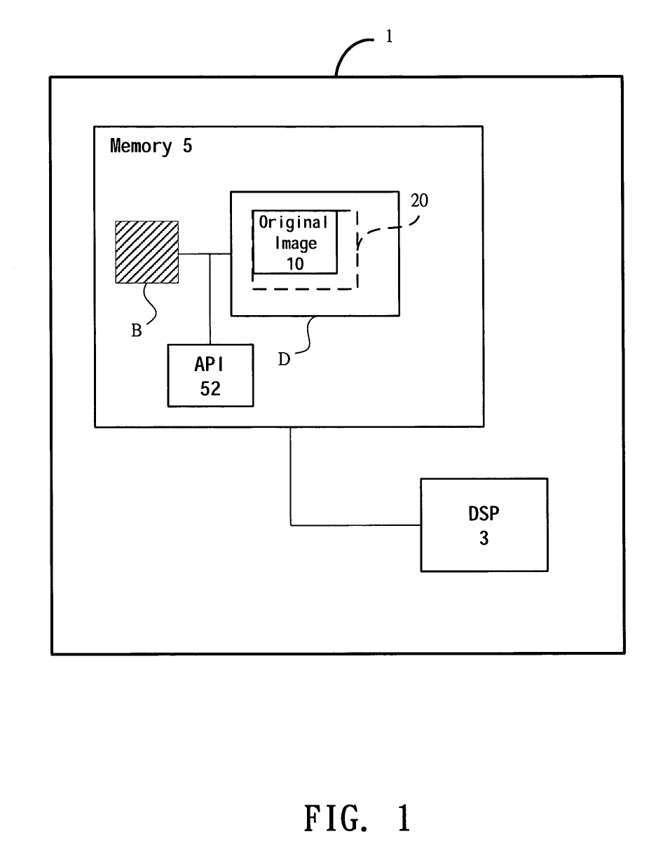

Please refer to FIG. 1. FIG. 1 is a functional block drawing of a digital camera according to the present invention. A digital camera 1 of the present invention comprises a digital signal processor (DSP) 3 and a memory 5. The digital camera 1 utilizes interpolation means to zoom in on an original image 10 to form an enlarged image 20 shown as dotted lines. The memory 5 comprises a buffer and an image data storage area D, and the original image 10 and the enlarged image 20 are all stored in the image data storage area D.

The original image 10, which may be captured by the digital camera 1, is stored in the memory 5 of the digital camera 1. The memory 5 can be implemented by a SDRAM in the digital camera 1. Additionally, the original image 10 in the present invention is not limited to only images captured by the digital camera 1, but may also be an imported image (for example, downloaded from a computer) stored in the memory 5 of the digital camera 1.

The digital signal processor 3 of the digital camera 1 is used for converting electronic signals generated by the CCD (not shown) in the digital camera 1 to a digital image and performing image processing. The memory 5 has an application program interface (API) 52, which can be used for calling the digital signal processor 3 to zoom in on the original image 10.

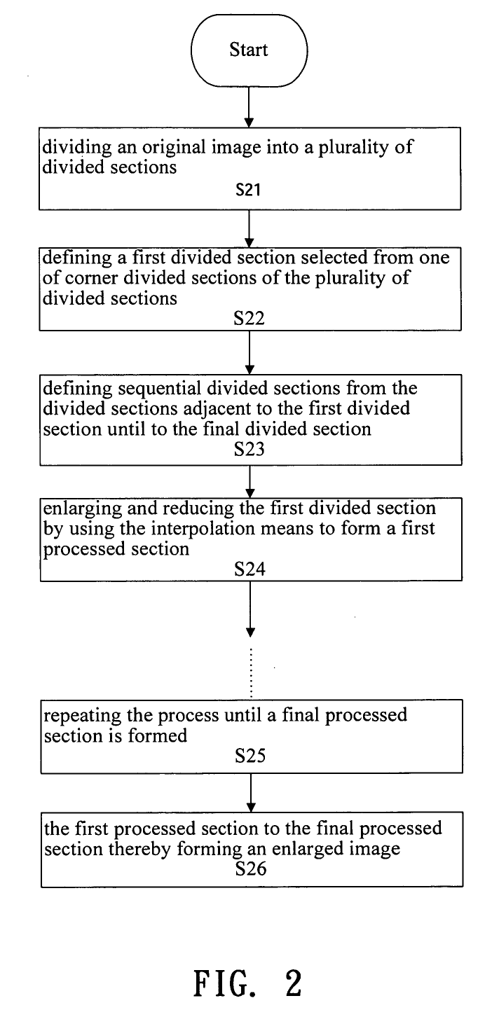

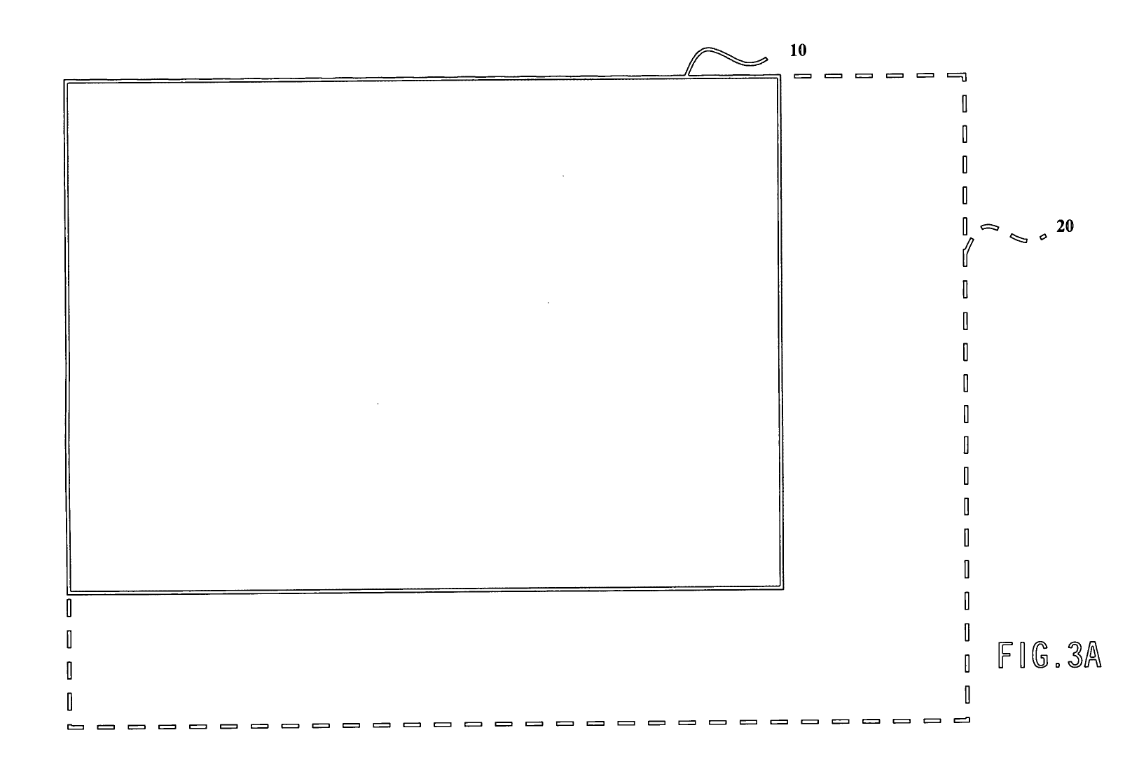

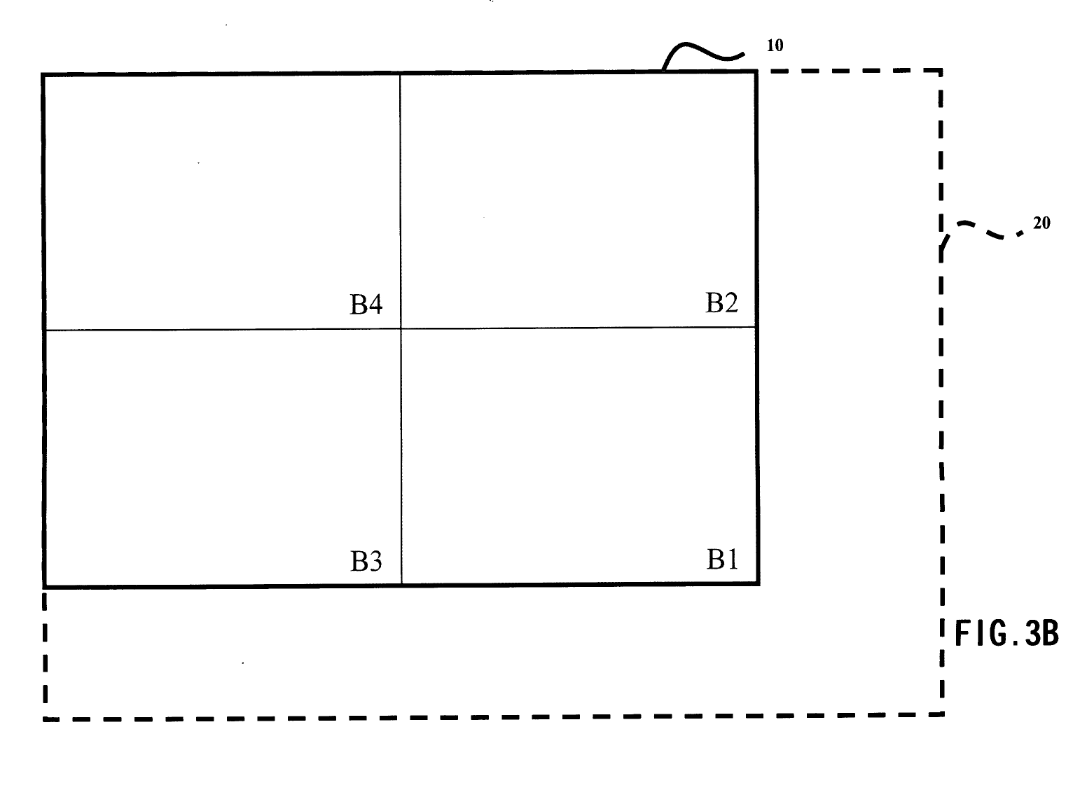

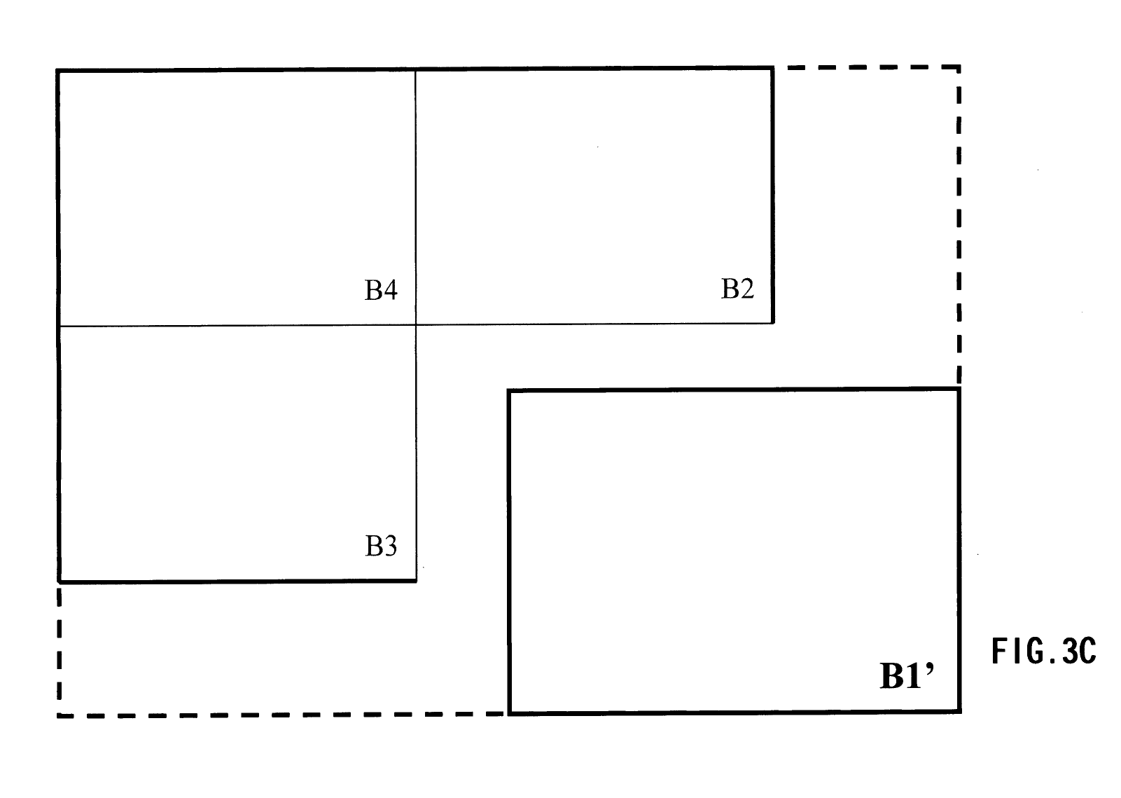

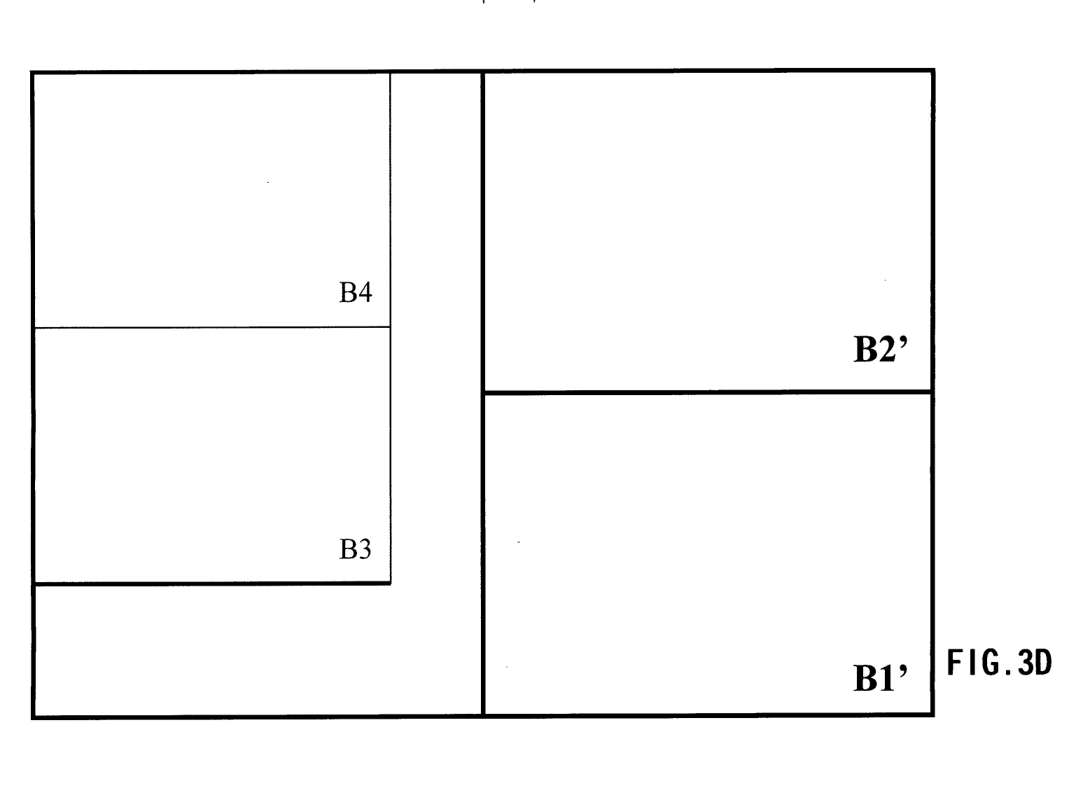

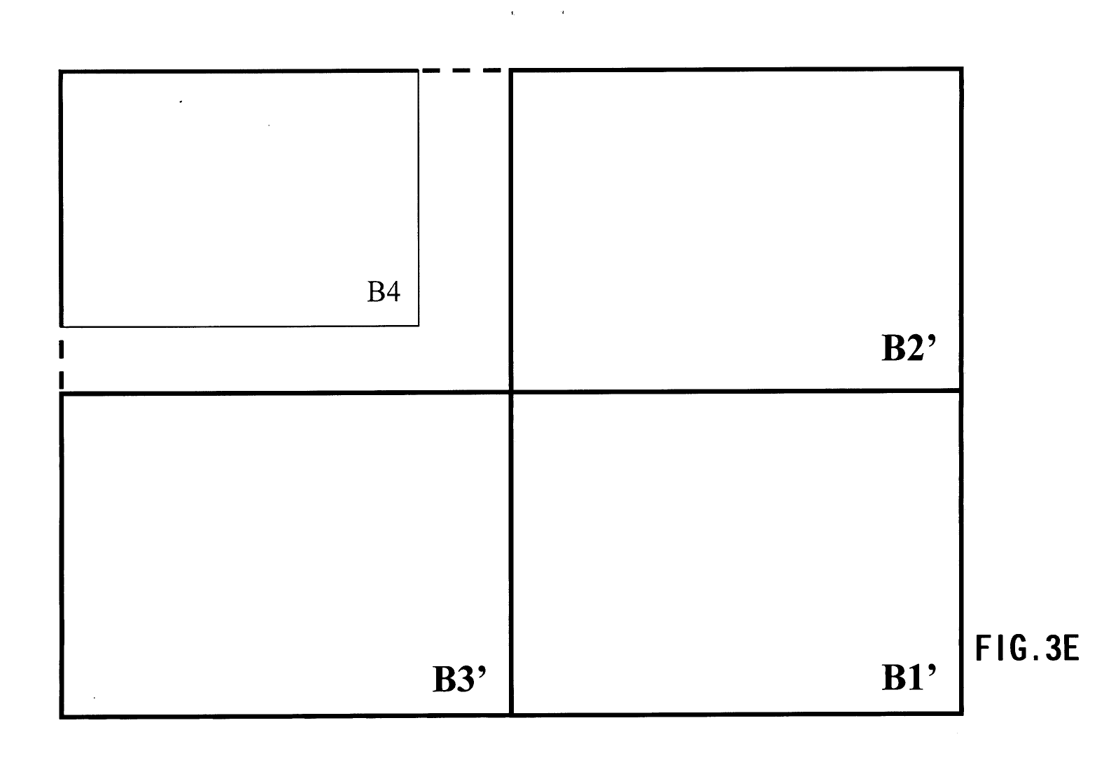

Please refer to FIG. 2. In step S21, the original image 10 is divided into a plurality of divided sections. Please refer to FIG. 3A; when a user obtains the original image 10, and if the user wants to zoom in on the original image 10 into an enlarged image 20, the method of the present invention may be performed. As shown in FIG. 3B, the original image 10 is divided into divided sections B1˜B4.

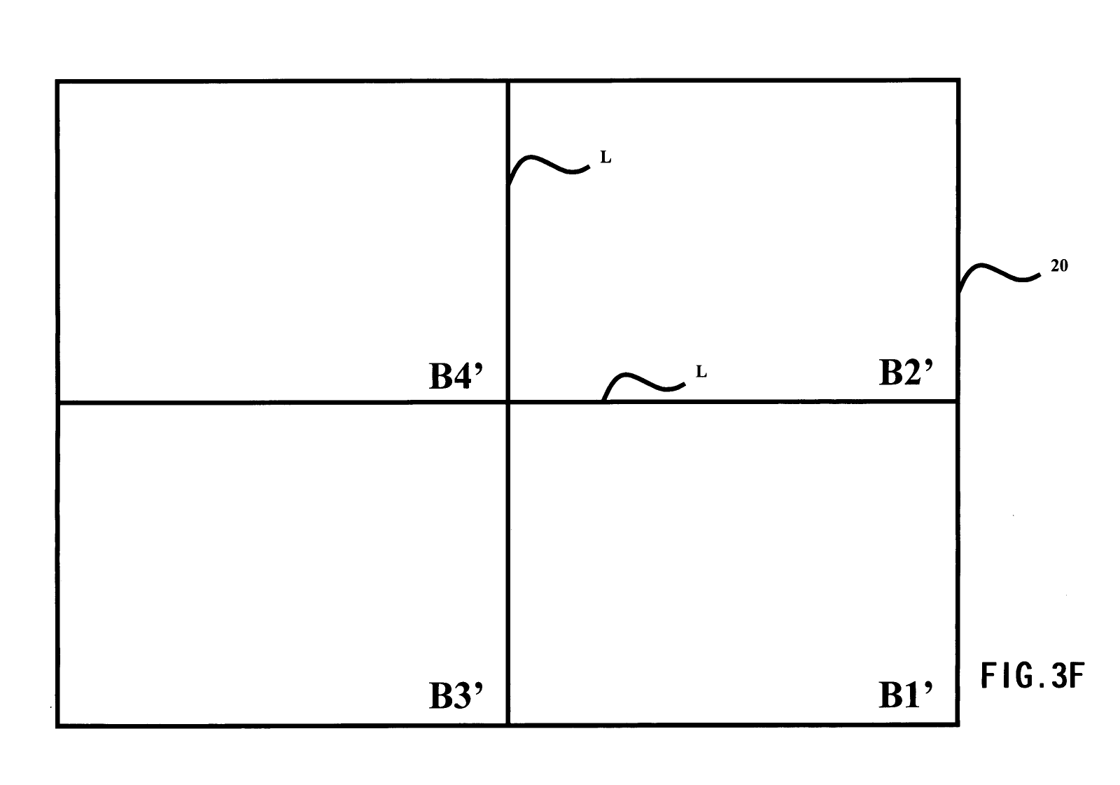

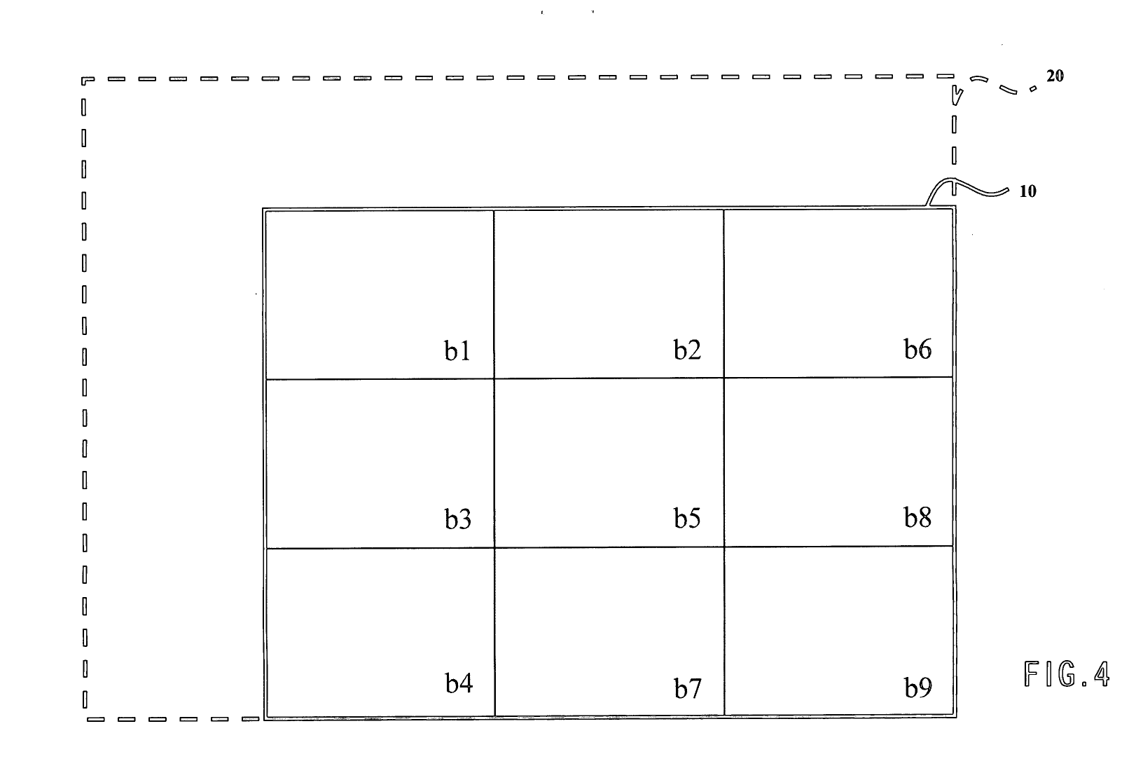

In FIG. 3A˜FIG 3F, the original image 10 is divided into four divided sections B1˜B4; however, it should be understood that the number of divided sections can vary; for example, as shown in FIG. 4, the original image 10 can be divided into nine divided sections b1˜b9. The number of divided sections B1˜B4 or b1˜b9 is depends on the size of the buffer B (as shown in FIG. 1). In other words, if the buffer B has a relatively large size, there may be fewer divided sections (such as B1˜B4), and each divided section B1˜B4 may have a relatively large size; on the other hand, the buffer B is smaller sized, there may be more divided sections (such as b1˜b9) and each divided section b1˜b9 may have a smaller size. In the following description, the divided sections B1˜B4 are used as examples.

Please refer again to FIG. 2. In step S22, one divided section at one corner of the divided sections B1˜B4 is defined as a first divided section. Please refer to FIG. 3B. In this embodiment, the divided section B1 is defined as the first divided section. The defined first divided section is selected from one of the divided sections B1˜B4 or b1˜b9, which is positioned at a corner, such as any one of divided sections B1, B2, B3, or B4, or any one of divided sections b1, b4, b6, or b9.

Next, in step S23, the second divided section, the third divided section . . . and the final divided section are all defined sequentially. Please refer to FIG. 3B; in this embodiment, the divided sections B2 and B3 adjacent to the first divided section B1 are defined as the second divided section B2 and the third divided section B3. However, choosing the second divided section as B2 and the third divided section as B3 is not the only option; the second divided section may be B3, and the third divided section may be B2. For convenience of description, the second divided section as B2 and the third divided section as B3 is used as an example. Sequentially, the fourth divided section B4 to the final divided section are defined. In this embodiment, the fourth divided section B4 is the final divided section.

Alternatively, with reference to FIG. 4, the divided sections b2 and b3 adjacent to the first divided section b1 may be defined as the second divided section b2 and the third divided section b3. Next, the fourth divided section b4 and the fifth divided section b5 adjacent to the second divided section b2 are defined, and the sixth divided section b6 adjacent to the third divided section b3 is defined. Next, the divided section adjacent to the fourth divided section b4 is defined as the seventh divided section b7, and the divided section adjacent to the fifth divided section b5 is defined as the eighth divided section b8. Finally, the divided section adjacent to both the seventh divided section b7 and the eighth divided section b8 is defined as the ninth divided section b9. The second divided section b2 and the third divided section b3 are not necessarily in sequence; neither are the fourth divided section b4, the fifth divided section b5, and the sixth divided section b6 in sequence; and the seventh divided section b7 and the eighth divided section b8 are not necessarily in sequence either.

With reference to FIG. 2, in step S24, the first divided section B1 is stored in the buffer B, and the interpolation means is utilized to enlarge the first divided section B1 by a first specific multiplier and reducing the enlarged first divided section B1 with a second specific multiplier. The first specific multiple is larger than the second specific multiplier; preferably, the first specific multiplier is 2, and the second specific multiple is 1.25×1.25. As a result, the first divided section B1 is enlarged as a first processed section B1′ by the interpolation means, and the first processed section B1′ is stored back into the image data storage area D. With reference to FIG. 3C, the first divided section B1 is stored in the buffer B. The interpolation means is used for enlarging the first divided section B1 by the first specific multiplier (such as 2) and reducing by the second specific multiplier (such as 1.25×1.25) so that the first divided section B1 is enlarged (such as by 1.28 times) to form the first processed section B1′. The first processed section B1′ is stored back into the image data storage area D.

With reference to FIG. 2, in step S25, the second divided section B2 is stored in the buffer B, and the interpolation means is utilized to enlarge the second divided section B2 by the first specific multiplier (such as 2) and to reduce the second divided section B2 by a second specific multiplier (such as 1.25×1.25). The second divided section B2 is therefore enlarged as a second processed section B2′ by the interpolation means, and the second processed section B2′ is stored back into the image data storage area D. Accordingly, eventually the final divided section B4 is enlarged by the first specific multiplier (such as 2) and reduced by the second specific multiple (such as 1.25×1.25) by the interpolation means to form the last processed section B4′. Please also refer to FIG. 3D˜FIG. 3F. As shown in FIG. 3D, the second divided section B2 stored in the buffer B utilizes the interpolation means for enlargement by the first specific multiplier (such as 2) and reduction by the second specific multiplier (such as 1.25×1.25) to form the second processed section B2′, and the second processed section B2′ is stored back into the image data storage area D. Next, as shown in FIG. 3E, the third divided section B3 stored in the buffer B utilizes the interpolation means for enlargement by the first specific multiplier (such as 2) and for reduction by the second specific multiplier (such as 1.25×1.25) to form the third processed section B3′, and the third processed section B3′ is stored back into the image data storage area D. Finally, as shown in FIG. 3F, the fourth divided section B4 stored in the buffer B utilizes the interpolation means for enlargement by the first specific multiplier (such as 2) and reduction by the second specific multiplier (such as 1.25'1.25) to form the fourth processed section B4′ (which is also the final processed section in this embodiment), and the fourth processed section B4′ is stored back into the image data storage area D.

With reference to FIG. 2, in step S26, all processed sections from B1′ to B4′ form the enlarged image 20 in the image data storage area D. As shown in FIG. 3F, the first processed section B1′ to the final processed section B4′ form the enlarged image 20, which is formed of enlarging the original image 10.

Generally, the enlargement or reduction multipliers of the digital signal processor 3 are constants, which indicates that the enlargement multiplier for the original image 10 is a fixed multiplier (such as 1.26 times or 1.28 times). Therefore, in the preferred embodiment of the present invention, the first specific multiplier is 2, and the second specific multiplier is 1.25×1.25. For example, the original image 10 may be a 3M pixel image, and the enlarged image 20 might be a 5M pixel image.

When the digital signal processor 3 processes the image, dividing lines L between every two divided sections B1˜B4 (as shown in FIG. 3F) may become noticeable. Therefore, in the preferred embodiment of the present invention, each divided section B1˜B4 has at least one overlapping area. After enlargement and reduction of the overlapped areas, the dividing lines L are not generated between the processed sections B1′˜B4′.

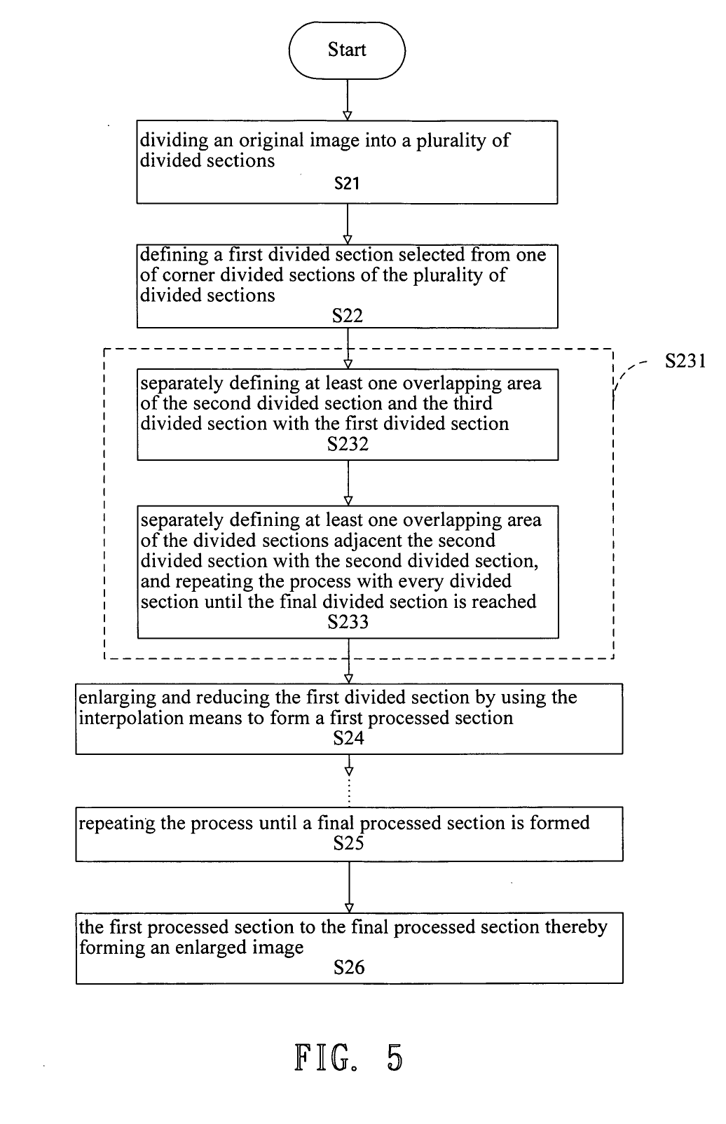

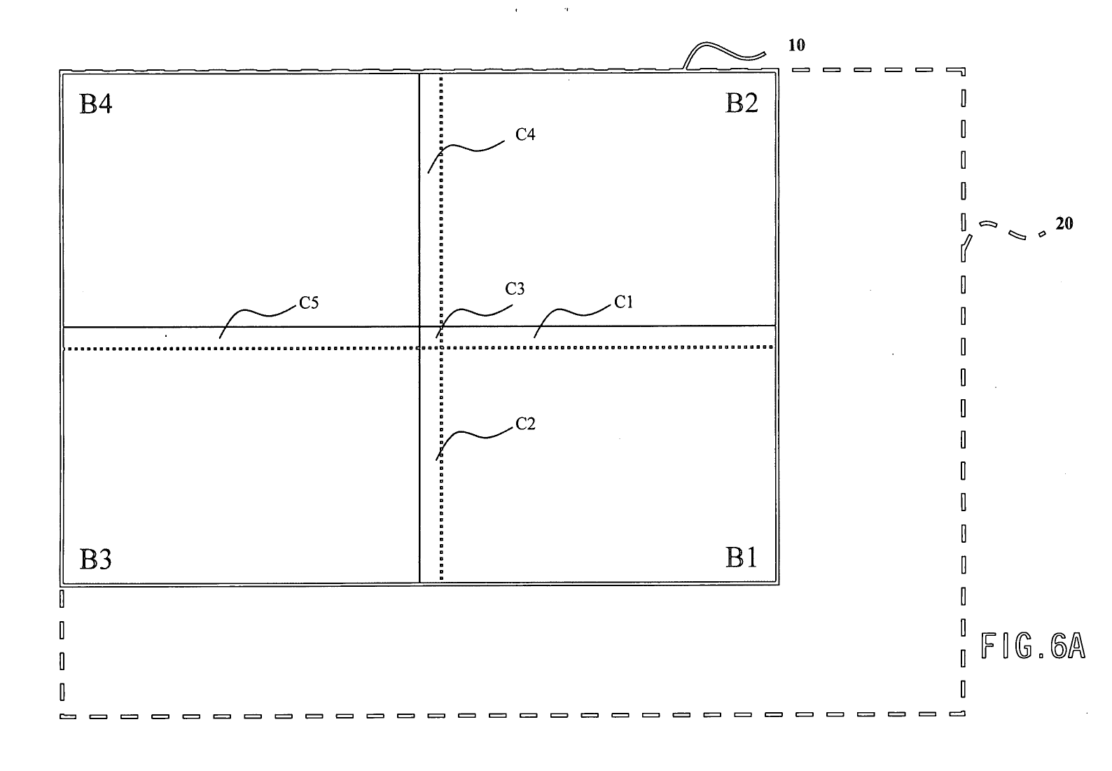

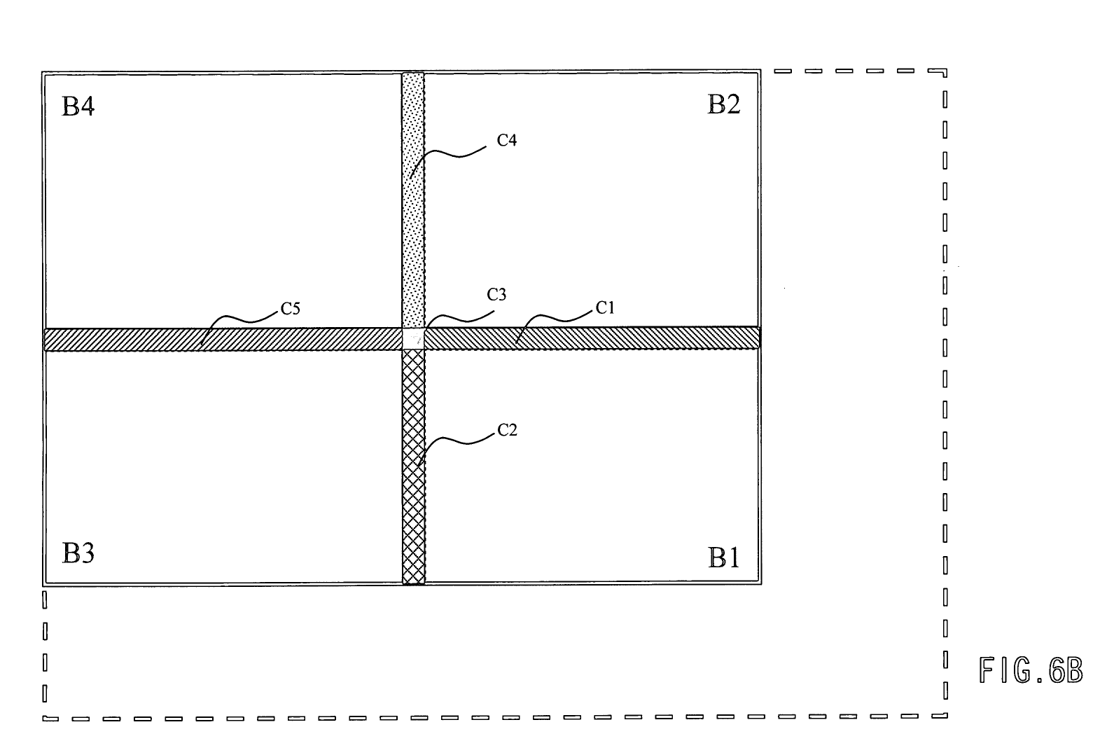

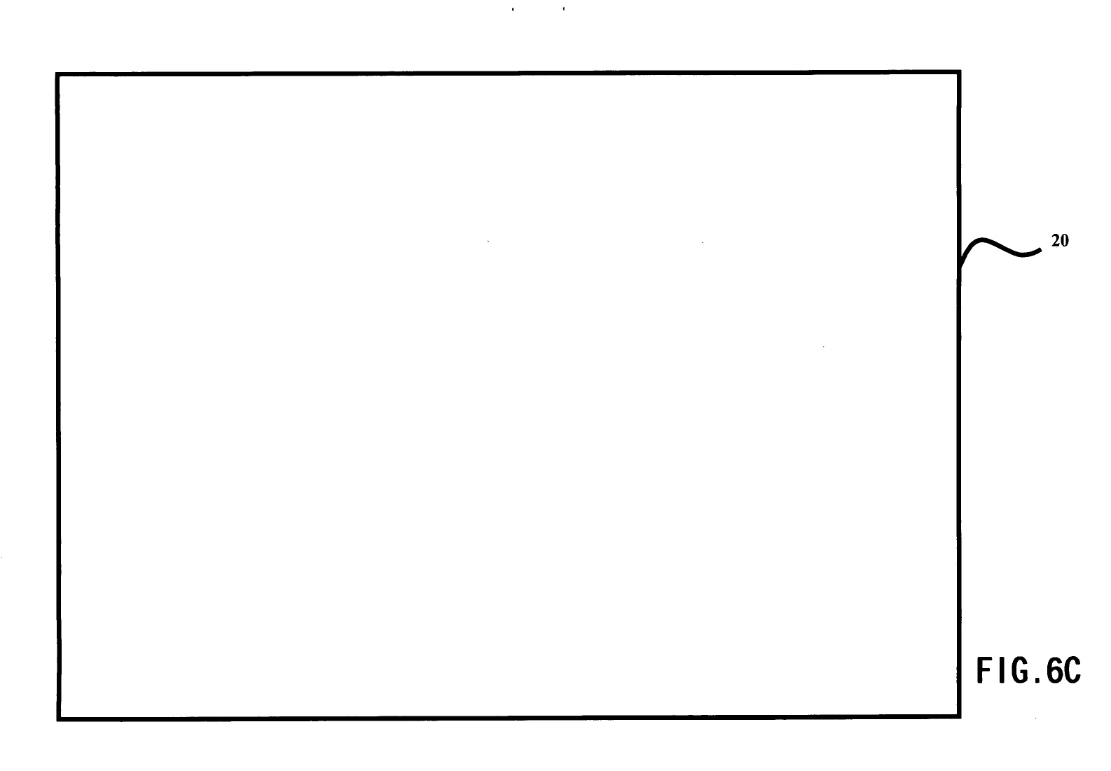

Please refer to FIG. 5. In one preferred embodiment, after step S22 of defining the first divided section B1, step S231 is performed to overlap at least one area of each divided section B1˜B4. When defining the divided sections B1˜B4, the overlapping areas are also defined. Therefore, step S231 may further comprise steps S232 and S233. With reference to FIG. 6A, the first divided section B1 is defined first, and the overlapping areas C1˜C5 are separately defined between every two divided sections among the divided sections B1˜B4.

Please refer to both FIG. 5 and FIG. 6B. In step S232, the larger second divided section B2 is extracted, so the second divided section B2 and the first divided section B1 have the overlapping areas C1, C3 between them; the larger third divided section B3 is extracted, and so the third divided section B3 and the first divided section B1 have the overlapping areas C2, C3.

Please refer to both FIG. 5 and FIG. 6B. In step S233, the larger fourth divided section B4 (also the final divided section in this embodiment) is extracted, and so the fourth divided section B4 and the second divided section B2 have the overlapping areas C4, C3 between them, and the fourth divided section B4 and the third divided section B3 share the overlapped areas C5, C3.

The digital signal processor 3 can be used for controlling the partition sizes of the divided sections B1˜B4 and for obtaining very minor differences. Therefore, this embodiment can make the overlapping areas C1˜C5 have widths of only 2 to 4 pixels. Steps S24, S25 and S26 are performed after step S232, as provided in the above-mentioned description.

By enlarging and reducing to enhance the overlapping areas C1˜C5, visible division lines L among the processed sections B1′˜B4′ are avoided, and so the entire enlarged image 20 appears more clear, as shown in FIG. 6C.

According to the method of the present invention, the enlarged image retains its picture quality, and every divided section (such as B1˜B4 or b1˜b9) is much smaller than the original image 10, which requires less memory capacity in the buffer, and further improves the entire processing performance of the digital camera.

Although the present invention has been explained in relation to its preferred embodiment, it is to be understood that many other possible modifications and variations can be made without departing from the spirit and scope of the invention as hereinafter claimed.

What is claimed is:

1. A method of enlarging an image with an interpolation means comprising:
(a) dividing an original image into a plurality of divided sections;
(b) defining a first divided section selected from one of corner divided sections of the plurality of divided sections;
(c) defining sequential divided sections from the divided sections adjacent to the first divided section thereto and continuing until defining a final divided section;
(d) enlarging the first divided section by a first specific multiplier and reducing by a second specific multiplier by using the interpolation means; wherein the first specific multiplier is larger than the second specific multiplier so that the first divided section is zoomed in as a first processed section by using the interpolation means; and
(e) enlarging the second divided section by the first specific multiplier and reducing by the second specific multiple by using the interpolation means to form a second processed section, and repeating the process until a final processed section is formed, the first processed section to the final processed section thereby forming an enlarged image.

2. The method as claimed in claim 1, wherein the first specific multiplier is 2 and the second specific multiplier is 1.25×1.25.

3. The method as claimed in claim 1, wherein each divided section has at least one overlapping area.

4. The method as claimed in claim 3, wherein step (c) further comprises:
separately overlapping at least one area of the second divided section and the third divided section with the first divided section; and
separately overlapping at least one area of the divided sections adjacent the second divided section with the second divided section, and repeating the process with every divided section until the final divided section is reached.

5. The method as claimed in claim 3, wherein the at least one overlapping area has a width of about 2 to 4 pixels.

6. A digital camera capable of enlarging an image with an interpolation means, the digital camera comprising:
a digital signal processor (DSP); and
a memory storing an application program interface (API), the memory comprising a buffer and an image data storage area, an original image capable of being stored in the image data storage area, and the application program interface usable for calling the digital signal processor to perform the following process:
(a) dividing an original image into a plurality of divided sections;
(b) defining a first divided section selected from one of corner divided sections of the plurality of divided sections;
(c) defining sequential divided section from the divided sections adjacent to the first divided section thereto and continuing until defining a final divided section;
(d) enlarging the first divided section by a first specific multiplier and reducing by a second specific multiplier by using the interpolation means; wherein the first specific multiplier is larger than the second specific multiplier so the first divided section is zoomed in as a first processed section by using the interpolation means; and
(e) enlarging the second divided section by the first specific multiplier and reducing by the second specific multiplier by using the interpolation means to form a second processed section, and repeating the process until a final processed section is formed, the first processed section to the final processed section thereby forming an enlarged image.

7. The digital camera as claimed in claim 6, wherein each divided section has at least one overlapping area.

8. The digital camera as claimed in claim 7, wherein the definition of the second divided section till to the final divided section includes:
at least one area of the second divided section and the third divided section separately has a overlapped area with the first divided section; and
every divided section adjacent to the second divided section has at least one overlapping area with the second divided section, and every divided section adjacent to the third divided section has at least one overlapping area with the third divided section . . . till every divided section adjacent to the final divided section has at least one overlapping area with the final divided section.

9. The digital camera as claimed in claim 7, wherein the at least one overlapping area has a width of about 2 to 4 pixels.

10. The digital camera as claimed in claim 6, wherein the first specific multiplier is 2 and the second specific multiplier is 1.25×1.25.
